(19) United States
(12) Patent Application Publication
(10) Pub. No.: US 2016/0067130 A1
(43) Pub. Date: Mar. 10, 2016

(54) METHOD AND APPARATUS FOR MOVING A HOSPITAL BED OR ANOTHER WHEELED OBJECT

(71) Applicant: Omni-Drive Holding ApS, Kvistgård (DK)

(72) Inventors: Lars Nøhr Kofoed, Rungsted Kyst (DK); Mogens Ilsted Bech, Birkerød (DK); Henrik Nøhr Kofoed, Espergærde (DK)

(21) Appl. No.: 14/891,094

(22) PCT Filed: May 15, 2014
(86) PCT No.: PCT/IB2014/061460

§ 371 Date: Nov. 13, 2015

(30) Foreign Application Priority Data
May 17, 2013 (DK) PA 2013 00300

(51) Int. Cl. A61G 7/08; B62B 5/00

(52) U.S. Cl. CPC A61G 7/08; B62B 5/0076; A61G 2203/12; A61G 2203/42

(57) ABSTRACT

A wheeled object, such as a bed (26), is moved by means of a separate driving device (10). The total driving device (10) including a motor driven driving wheel (15) has such dimensions that it may be substantially fully housed in the space defined between lower surface of the bed and the floor surface and is moved into such space. Thereafter an upper surface (21) of the driving device is moved into force transmitting engagement with the lower surface of the bed or object and the driving wheel (15) is moved into driving engagement with the supporting surface or floor. A separate control unit (24) communicating with the motor driven driving wheel may then be operated so as to energize the driving means and move said object. Because the driving device does not extend substantially beyond the outlines of the bed (26) or object, a highly increased maneuverability is obtained.

### BACKGROUND OF THE INVENTION

The present invention relates to a method for moving a wheeled object, such as a hospital bed, along a supporting surface or floor by means of a separate driving device. The objects to be moved are of the type defining a gap or space between the floor and a lower surface of the object positioned at a higher level, such as the bottom surface of a bed frame supported by bed legs with wheels.

Hospital beds and other manually movable objects are usually provided with casters, wheels, rollers or other means allowing the objects to be pushed manually, such objects are herein designated “wheeled objects”. However, if the objects have to be moved longer distances driving devices in the form of so-called bed or trolley movers or bed tractors may be used. When such known driving devices are connected to an end of the bed or object to be moved, all or a major part of the driving device extends beyond the outline of the bed or object. This means that manoeuvering of the object requires a relatively large space and that the bed lifts in hospitals normally are too small for housing such known bed mover with a hospital bed connected thereto.

### BRIEF DESCRIPTION OF THE INVENTION

The present invention provides a method for moving a wheeled object by means of which the manoeuverability of the object may be substantially improved and the above mentioned problem may be solved.

Thus, the method according to the invention comprises moving the total driving device, including a motor driven driving means, substantially fully into the gap or space defined between the floor and the said lower surface of the bed or object, moving an upper surface of the driving device into force transmitting engagement with the lower surface of the object, moving the driving means into driving engagement with the supporting surface or floor, and operating a separate control unit communicating with the motor driven driving means so as to energize the driving means and move said object.

Because the driving device does not extend substantially beyond the outlines of the object or bed to be transported the total assembly does not occupy more space than the object itself, whereby the manoeuverability of the object is improved substantially. Furthermore, the separate control unit may be arranged in any desired position on the object to be moved, or the control unit may be handheld. Thus, the driving device may be operated from any convenient position. The force transmitting engagement between the upper surface of the driving device and the lower surface of the object may be obtained in any suitable manner, such as by shaping these two surfaces so that they may fit into each other or by providing these surfaces with an anti-skid material.

The upper surface of the driving device may be moved into force transmitting engagement with the lower surface of the object, for example by means of suitable actuators, springs, or the like, and the driving means may be moved into driving engagement with the supporting surface or floor by similar separate actuators or springs. In the presently preferred embodiment the said upper and lower surfaces are moved into force transmitting engagement when the driving means is moved into driving engagement with the supporting surface or floor, which means that the same biasing means, such as actuators or spring devices, is used for moving the said upper and lower surfaces into engagement and for forcing the driving means into driving engagement with the floor.

If the driving means are moved into engagement with the supporting surface or floor with a sufficiently high force, this may allow manually turning of the object or bed around a vertical axis defined by the contact point between the driving means and the supporting surface or floor surface, so that the manoeuverability of the object is improved substantially. It has been found that a force corresponding to 40-95%, preferably 70-90%, and more preferred approximately 80% of the total combined weights of the object being moved and of the driving device is suitable.

The control unit may be connected to the driving device by means of an electric cord, preferably of the extensible type. It is preferred, however, that the control unit and the driving device are communicating wirelessly, so that the driving device may be moved into and out of the gap or space below the object or bed frame in any direction without entangling a cord with parts of the object no matter where the control unit is arranged.

The control unit may, for example, have control buttons marked “Forward”, “Backward”, “Right”, and “Left”. When an operator wants to move a hospital bed or another wheeled object by using the method according to the invention he or she may grip the bed at and position the control unit on either the headboard or the footboard. When the operator actuates a button “Forward” of the control unit he/she would intuitively expect the bed to be driven in the direction he/she is facing no matter at which end of the bed the control unit is positioned. Therefore, the “Forward” direction is preferably defined as the direction from the control unit towards the driving device, and according to the invention the position of the driving device in relation to the control unit may be determined by electronic direction means, such as electronic compasses, installed in the driving device and the control unit, respectively.

Preferably, the driving device is arranged in such a position under the object to be moved that the driving means of the driving device is positioned on or close to a vertical line through the gravity center of such object. The bed or object may then more easily be manually manoeuvered or turned around the contact point of the driving means with the supporting surface or floor. The driving means may be of any kind, such as a driving belt. Preferably, however, it comprises at least one driving wheel or driving roller.

When the object is to be driven upwardly along an inclined surface the driving means must be forced harder into contact with the supporting surface or floor in order to avoid slipping. If on the other hand the bed or object is to be moved downwardly along an inclined surface the friction between the driving means and the floor surface should be sufficient to prevent the object from moving unintentionally fast. Therefore, the driving device may comprise inclination means for defining the inclination of the supporting surface and means for evaluating the risk of undue movement of the object under the influence of gravity.

In addition to the driving means the driving device may have supporting wheels, such as casters, and sensing means allowing the driving means to automatically move the driving device into position in said gap or space beneath the object or bed, when a corresponding button of the control unit has been actuated. The supporting wheels may be mounted resiliently vertically in relation to the driving means. In that case the driving means may be forced into driving engagement with the supporting surface or floor by moving the upper surface of the driving device into force transmitting engagement with said lower surface of the bed or wheeled object.

The invention further provides a driving device for moving a wheeled object of the type having a lower surface positioned above a supporting surface or floor, so as to define a gap or space there between, such as a bed, along such supporting surface or floor, said device having dimensions allowing it to be substantially fully housed in the gap or space defined below said lower surface, said driving device comprising a frame defining an upper surface thereof, motor driven driving means mounted on said frame, means for forcing the frame upwardly so as to move the upper surface of the frame into force transmitting engagement with the lower surface of the object when positioned in said gap or space, means for moving the driving means into driving engagement with the supporting surface or floor, and a separate control unit for controlling the operation of the forcing means, the moving means and the motor driven driving means.

The motor driven driving means may be mounted rotatably about a substantially vertical axis in relation to the frame so as to allow change of the driving direction of the driving wheel by rotating the driving means about such axis into the desired angular position.

In principle, the motor driven driving means could be biased into contact with the supporting surface or floor by biasing means positioned between the lower surface of the object and the upper surface of the device frame. It is preferred, however, that the motor driven driving means is movable vertically in relation to the frame. Such biasing means may be of any suitable type, such as actuators, pneumatic or hydraulic cylinders or springs, such as a gas spring. Because it is important that the contact pressure between the driving means and the supporting surface or floor can be adapted to the varying circumstances—such as weight and load of the object being moved and inclination and surface characteristics of the floor—it is important that the biasing force of the biasing means is adjustable.

Separate biasing means may be used for biasing the upper surface of the device frame into force transmitting contact with the lower surface of the object to be moved and for biasing the driving means into driving contact with the supporting surface or floor, respectively. However, it is preferred that the biasing means for forcing the device frame upwardly comprises said adjustable biasing means for forcing the driving means into driving contact with the floor.

The driving means may be movable along a substantially vertical path by means of actuators or pneumatic or hydraulic cylinders. In the preferred embodiment the driving means is mounted at one end of an arm or a lever, which is rotatable about a substantially horizontal axis, so that the driving means are movable along an arc of a circle.

The driving means and the moving means are preferably arranged in a cylindrical housing of a driving unit which is mounted centrally in the device frame so as to be rotatable about a substantially vertical axis. Thereby the driving direction of the driving means or driving wheel may be changed by rotating the driving unit in relation to the device frame.

As mentioned above, the driving device may comprise electronic direction means installed in the driving device and the control unit, respectively, for determining the position of the driving device in relation to the control unit, as well as inclination means for defining the inclination of the supporting surface and means for evaluating the risk of undue movement of the object under the influence of gravity.

The driving device may be provided with supporting wheels, such as casters, mounted on the frame for supporting the driving device when moved in position by the driving means beneath the object to be moved. These supporting wheels may more or less be lifted out of contact with the floor when the driving means is biased into driving contact with the supporting surface or floor. The driving device may also have sensors allowing the driving means to automatically move the driving device into position beneath the object to be moved when a corresponding button of the control unit is touched.

### BRIEF DESCRIPTION OF THE DRAWINGS

The invention will now be further described with reference to the drawings, wherein

FIG. 1 is a perspective view of an embodiment of the driving device according to the invention,

FIG. 2 is a side view of the driving device shown in FIG. 1,

FIG. 3 is a perspective view illustrating how the driving device may be positioned under a hospital bed,

FIG. 4 is a perspective view illustrating the driving device in its fully docked position under the bed ready to move the same,

FIG. 5 is a bottom view of the driving device,

FIG. 6 is a side view in an enlarged scale of a driving unit forming part of the driving device shown in FIGS. 1-5,

FIG. 7 is a bottom view of the driving unit shown in FIG. 6,

FIG. 8 is a bottom view of the driving unit shown in FIGS. 6 and 7, where a bottom cover plate has been removed, and

FIGS. 9-12 are side views of the driving unit viewed from different directions, a cylindrical housing of the driving unit having been removed.

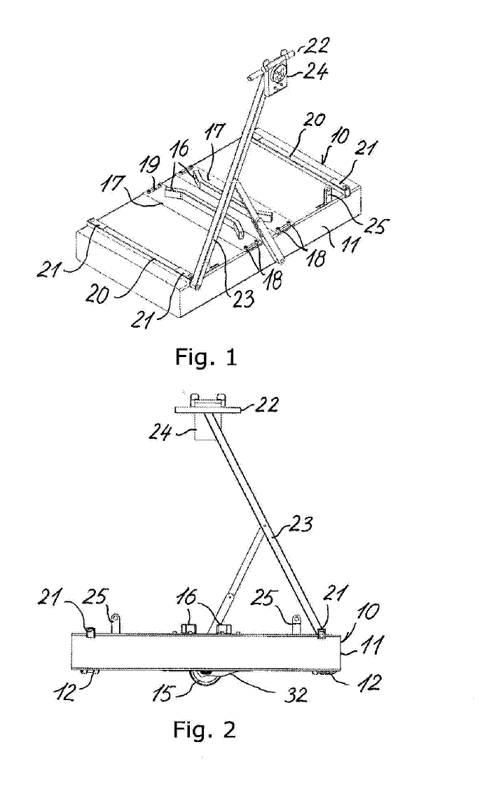

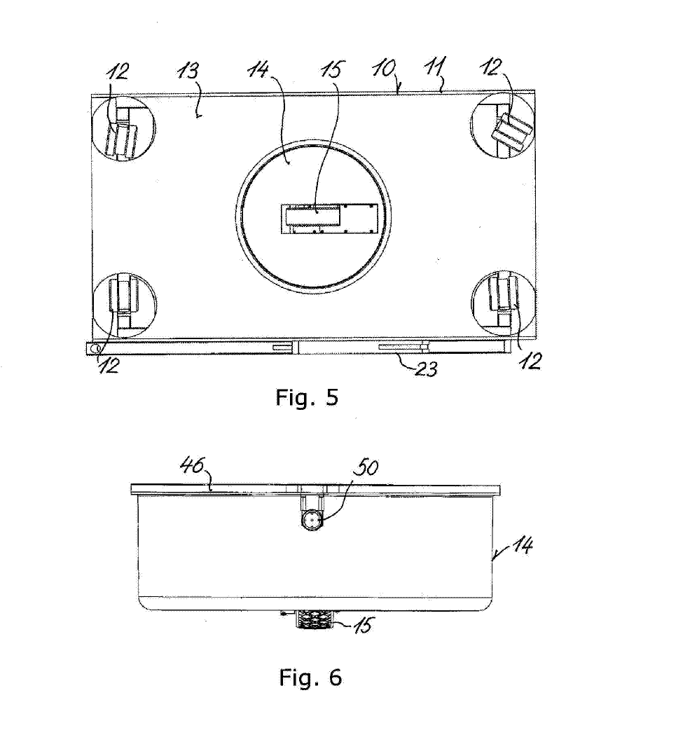

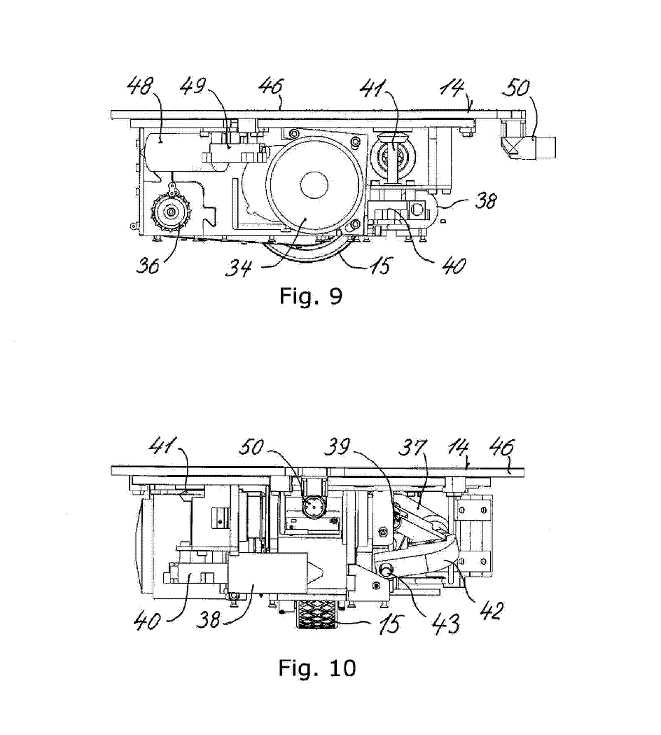

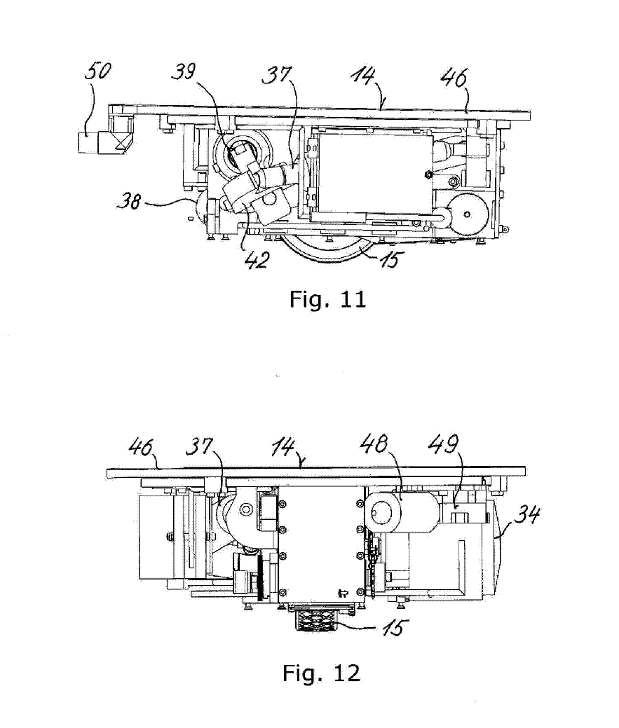

The driving device 10 shown in FIGS. 1 and 2 comprises a device frame 11, which is supported by four supporting caster wheels 12 each arranged in a corner of the substantially rectangular frame 11. The freely swirlable caster wheels extend downwardly through openings in a bottom plate 13 of the frame 11, and a substantially cylindrical driving unit 14 is rotatably mounted in the middle of the device frame 11, vide FIG. 5. As explained more in detail in connection with FIGS. 6-12 the driving unit 14 comprises a motor driven driving wheel 15 which is movable vertically in relation to the device frame and may be biased adjustably into contact with a floor surface, and the driving unit 14 may be rotated about a substantially vertical axis so as to change the driving direction of the driving wheel 15.

A pair of spaced, transversely extending guide rails 16 are fixed to mounting plates 17, which are in turn mounted on the upper side of the frame 11 by means of screws 18. These screws extend through slits 19 in the mounting plates 17 so as to allow adjustment of the position of the guide rails 16 on the frame 11. A pair of contact rails 20 arranged at opposite ends of the driving device 10 on the upper surface thereof are provided with pads 21 of a non-skid material, and a handle 22 is connected to a side surface of the device frame 11 by means of a linkage 23 allowing the handle to be folded from an upper position of use shown in FIGS. 1-3 into a retracted inactive position as shown in FIG. 4, in which it does not extend substantially beyond the limits of the device frame 11.

In FIGS. 1-3 a separate control unit 24 for remote controlling the operation of the driving device is shown attached to the handle 22, but it may be handheld or placed in any other convenient position. A pair of stop pawls 25 are arranged at the same side of the device frame 11 as the linkage 23 and are mounted so as to be rotatable between an extended position in which they extend upwardly from the upper surface of the frame 11 as shown in FIGS. 1-4 and a retracted position in which they are located mainly below the upper surface of the device frame 11.

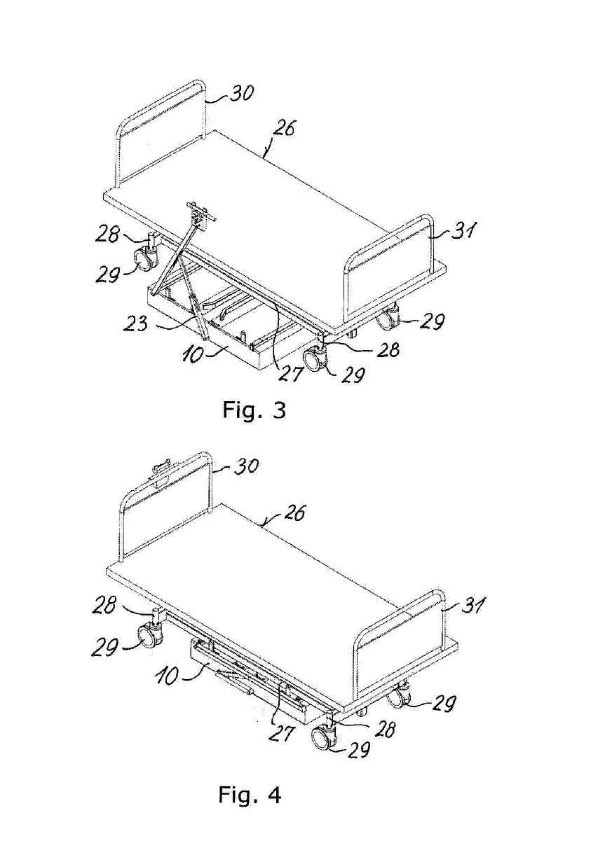

FIGS. 3 and 4 show a hospital bed 26 of the type having a bed frame 27, which is supported by four legs 28 each having a caster wheel 29 mounted thereon. A person may move such a wheeled bed manually along a short distance by gripping the head board 30 or foot board 31. However, when the bed is to be moved a relatively long distance it is conventional to use a motor driven bed mover or bed tractor, which is connected to one end of the bed. Because a major part of a conventional bed mover or tractor is positioned outside the outline of the bed 26 being towed a relatively large space is required for manoeuvering.

When the driving device 10 according to the invention is to be used for moving a wheeled object, such as a hospital bed 26, it may first be moved into a position next to one side of the bed as shown in FIG. 3. The motor driven driving wheel 15 may be biased into driving contact with the floor surface and its driving motor may be operated by means of the control unit 24, whereby the driving device which is supported by the caster wheels 12 may be directed to the position shown. Now, the handle 22 and its linkage 23 may be folded into its retracted inactive position, and the driving device may be directed transversely to the bed side so that the device is moved into the space below the bed frame 27. The mutually spaced guide rails 16 are adapted to engage with a corresponding transverse rib or rail (not shown) at the bottom surface of the bed frame, and the spacing of the guide rails 16 is increased at their opposite ends in order to facilitate catching of the bed rib or rail there between. At this point the stop pawls 25 are in their upwardly extending position so as to abut the side surface of the bed when the driving device 10 is fully inserted under the bed. Now, the driving wheel 15 is biased into further engagement with the floor surface so as to carry 40-95%, preferably about 80%, of the combined weight of the bed 26 and the driving device 10. Consequently, the pads 21 are pressed upwardly into firm engagement with corresponding parts of the bottom surface of the bed frame. Preferably weight sensors or weighing cells are provided at each of the pads 21. It may then be secured that the motor driven driving wheel 15 cannot be operated unless the weight sensors indicates that the driving device is correctly positioned and carry a predetermined minimum weight. It should be understood that the mounting plates 17 with the rails 16 can be adjusted or replaced so as to adapt the driving device to various types of beds.

The movement of the driving device 10 and the bed carried thereby may be fully controlled by means of the separate control unit 24 which may, for example, be attached to the head board 30 or foot board 31 of the bed, or it may be handheld. The function of the driving unit 14 may be wirelessly remote controlled by means of the control unit 24, or the control unit may be connected to the driving unit by an extensible cord. As explained more in detail later the driving unit 14 and therefore also the driving wheel 15 may be rotated about a vertical axis between two or more angular positions, whereby the driving direction may be changed.

Because a major part of the weight of the bed is carried by the centrally arranged driving wheel 15 the bed can also easily be turned manually about a central turning point defined by the driving wheel. It is understood that when the driving device 10 according to the invention is in use it is almost fully received in the space defined below the bed frame 27 and within the rectangular area defined by the bed wheels 29. Therefore, the manoeuvrability is substantially improved. When the bed has been moved to its desired position, the bias of the driving wheel 15 is decreased and the driving device 10 is released from the bed and driven in a transverse direction out from the space below the bed frame—either opposite to that in which it was driven into the space or further in the same direction. In the latter case the stop pawls 25 are first rotated into their retracted position.

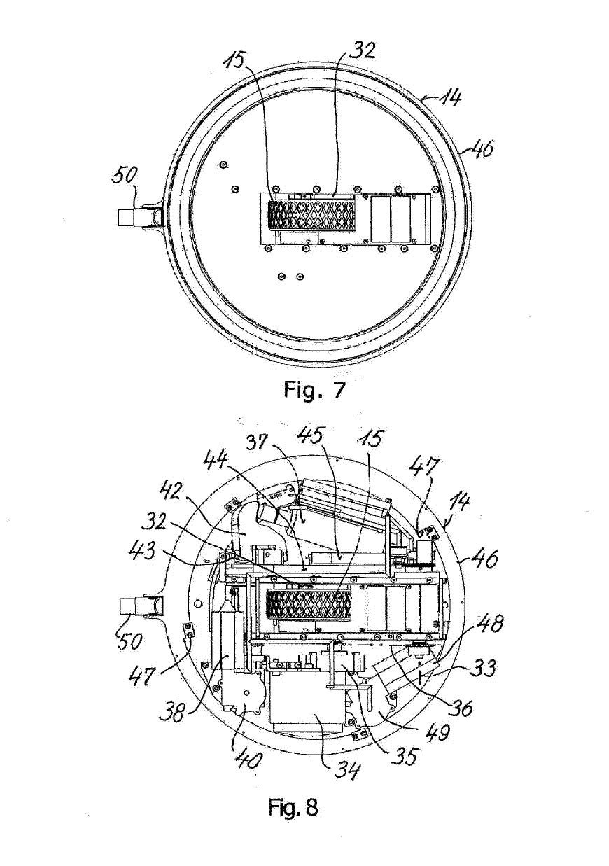

In the following the driving unit 14 is described in more detail with reference to FIGS. 6-12. The driving wheel 15 is rotatably mounted at the free end of an arm or lever 32 which is tiltable about a substantially horizontal axis 33, FIG. 8. The driving wheel 15 may be driven by an electric motor 34 via a gear box 35 and a pair of chain drives 36. One of the chain drives interconnects the gear box 35 and a sprocket on a shaft extending along the axis 33 and the other interconnects said shaft with the driving wheel 15 so as to allow the arm 32 to swing up and down around the axis 33. The driving wheel 15 may be biased into engagement with the floor surface by the force from a gas spring 37. The bias applied to the driving wheel 15 by the gas spring 37 may be adjusted by a pressure adjusting mechanism. Thus, via a gear box 40 and a gear transmission 41 an electric motor 38 may rotate a spindle device 39 which is hinge connected to a flap member 42. The flap member is tiltable about a shaft 43, and the movable end of the gas spring 37 is link connected to the flap member 42 at a position spaced from the axis of the shaft 43. The flap member 42 is connected to the lever 32 via a pull rod 44, FIG. 7. This means that the force of the gas spring may be transmitted to the driving wheel 15 via the flap member 42, the pull rod 44 and the lever 32. It should be understood that the force transmitted may be adjusted by rotating the spindle device 39 by means of the motor 38 in one direction or the other so as to tilt the flap member 42 about the shaft 43. As best shown in FIG. 7, a mechanical spring 45 is connected to the pull rod 44 so as to move the driving wheel 15 out of contact with the floor surface when the flap member 42 has been moved to an angular position in which the force transmitted from gas spring 37 to the driving wheel 15 is at a minimum.

The driving unit 14 is mounted in the device frame 11 so as to be rotatable about its central vertical axis in relation to a mounting flange 46 which may be fastened to the device frame. Thus, the driving direction of the driving device 10 may be changed by rotating the driving unit 14 in relation to the frame 11. In the embodiment shown in the drawings the unit 14 may be rotated between only two angular positions corresponding to forward-backward and sideward right-sideward left, respectively. These two rotational positions are indicated by steps 47 formed in the inner contour of the flange 46. The driving unit 14 may be rotated between the said positions by means of an electric motor 48 and a corresponding gear box 49. A pinion fastened to the output shaft of the gear box 49 may for example engage with a toothed rim on the inner surface of the mounting flange 46.

A plug 50 mounted on the mounting flange 46 may connect the various electrical motors and other electrical devices of the driving unit 14 to a battery (not shown) arranged in the device frame 11 or to another electrical source. The function of the said motors may be controlled by an operator by means of the control unit 24 which may be connected thereto by an extensible cord via the plug 50. Preferably, however, the drive unit 14 is wirelessly remote controlled by the control unit. The bias of the driving wheel 15 into contact with the floor surface is preferably adjusted automatically. As an example, the bias may be detected by weighing cells arranged for example under the pads 21. When the bias reaches a maximum it indicates that the total weight of the bed is carried by the driving device 11 and the bias may then be diminished approximately one fifth.

It should be understood that the above description is an example only, and that various amendments and modifications may be made without departing from the scope of the invention as defined by the attached claims.

1. A method for moving a wheeled object along a supporting surface or floor, wherein said wheeled object has a lower surface positioned above a supporting surface, so as to define a gap or space there between said method comprising:
moving a driving device, comprising a frame and supporting wheels mounted thereon for supporting the driving device when moved in position beneath the object to be moved and a motor driven driver, substantially fully into said gap or space,
moving an upper surface of the driving device into force transmitting engagement with the lower surface of the object,
moving the driver into driving engagement with the supporting surface or floor, and
operating a separate control unit communicating with the motor driven driver so as to energize the driver and move said object,
wherein the motor driven driver is movable vertically in relation to the frame, and in that the upper surface of the driving device is moved into force transmitting engagement with the lower surface of the object by moving the driver into driving engagement with the supporting surface or floor so as to lift the supporting wheels out of contact with said floor.

2-23. (canceled)

24. The method according to claim 1, wherein the driver is moved into engagement with the supporting surface or floor with a force corresponding to 40-95%, 70-90% or approximately 80% of the total combined weights of the object being moved and of the driving device.

25. The method according to claim 1, wherein the control unit and the driving device are communicating wirelessly.

26. The method according to claim 1, wherein the position of the driving device in relation to the control unit is determined by electronic direction detector installed in the driving device and the control unit, respectively.

27. The method according to claim 1, wherein the driving device is arranged in such a position under the object to be moved that the driver of the driving device is positioned on or close to a vertical line through the gravity center of such object.

28. The method according to claim 1, wherein the driver comprises at least one driving wheel or driving roller.

29. The method according to claim 1, wherein the driving device comprises inclination means for defining the inclination of the supporting surface and means for evaluating the risk of undue movement of the object under the influence of gravity.

30. The method according to claim 1, wherein the driving device is moved into an operating position in said gap or space by the driver while being supported by supporting wheels mounted on the device.

31. A driving device for carrying out the method according to claim 1, said device having dimensions allowing it to be substantially fully housed in the gap or space defined below said lower surface, said driving device comprising:
a frame defining an upper surface thereof,
a motor driven driver mounted on said frame,
supporting wheels mounted on the frame for supporting the driving device when moved into a desired operating position below the wheeled object,
a means for forcing the frame upwardly so as to move the upper surface of the frame into force transmitting engagement with the lower surface of the object when housed in said gap or space,
a means for moving the driver into driving engagement with the supporting surface or floor, and
a separate control unit for controlling the operation of the forcing means, the moving means and the motor driven driver,
wherein the motor driven driver is movable vertically in relation to the frame, and that the means for moving the frame upwardly and the means for moving the driver into driving engagement comprise an adjustable biasing member configured to bias the driver into driving engagement with the supporting surface or floor, whereby the supporting wheels are lifted out of contact with the supporting surface or floor.

32. The driving device according to claim 31, wherein the motor driven drivers comprises at least one driving wheel or roller.

33. The driving device according to claim 31, wherein the motor driven driver is mounted rotatably about a substantially vertical axis in relation to the frame so as to allow change of the driving direction of the driving wheel.

34. The driving device according to claim 31, wherein the driver is mounted at one end of an arm, which is rotatable about a substantially horizontal axis.

35. The driving device according to claim 33 comprising a driving unit having a cylindrical housing containing the driver and the moving means, the driving unit being mounted centrally in the device frame so as to be rotatable about a substantially vertical axis.

36. The driving device according to claim 31, wherein the control unit and the driving device are communicating wirelessly.

37. The driving device according to claim 31, further comprising an electronic direction detector installed in the driving device and the control unit, respectively, for determining the position of the driving device in relation to the control unit.

38. The driving device according to claim 31, further comprising an incliner configured to define the inclination of the supporting surface and a sensor for evaluating the risk of undue movement of the object under the influence of gravity.

39. The driving device according to claim 31, further comprising sensors for sensing when the driving device is in the said desired operating position.

40. The driving device according to claim 31, further comprising an upwardly extending handle for use in manually moving the driving device to a position next to the wheeled object, said handle being foldable into a substantially horizontal, inactive position.
